(19) United States
(12) Patent Application Publication
(10) Pub. No.: US 2014/0310960 A1
(43) Pub. Date: Oct. 23, 2014

(54) Skin Engaging Member For A Razor Cartridge

(71) Applicant: Eveready Battery Company Inc., St. Louis, MO (US)

(72) Inventors: Gabriel Ariyanayagam, Woodbridge, CT (US); Chris Barone, Trumbull, CT (US); Jeffrey Lieder, Beacon Falls, CT (US); Nathan Venskytis, Hamden, CT (US)

(73) Assignee: Eveready Battery Company Inc., St. Louis, MO (US)

(21) Appl. No.: 14/259,419

(22) Filed: Apr. 23, 2014

Related U.S. Application Data
(60) Provisional application No. 61/814,893, filed on Apr. 23, 2013.

(51) Int. Cl. B26B 21/40

(52) U.S. Cl. CPC B26B 21/4068; B26B 21/4037
USPC 30/34.05; 76/119

(57) ABSTRACT

A skin engaging member of a razor cartridge is formed from a precursor of a matrix of a first water soluble polymer and a water insoluble polymer. The precursor includes an upper surface region. A powdered second water soluble polymer is applied to an outer surface of the upper surface region. The second water-soluble polymer is mechanically pressed (e.g. by a roller) to embed the second water soluble polymer in the upper surface region. The upper surface region of the skin engaging member has a locally increased combined first and second water soluble polymer content.

### CROSS REFERENCE TO RELATED APPLICATIONS

This application claims the benefit of U.S. provisional patent application Ser. No. 61/814,893, filed Apr. 23, 2013, the content of which is incorporated herein for reference in its entirety.

### TECHNICAL FIELD

The present disclosure relates to a skin engaging member, also known as a shaving aid composite or lubricating strip for a razor cartridge.

### BACKGROUND

In some commercial razor cartridges for safety razors, a water soluble shaving aid, e.g., polyethylene oxide of one or more molecular weights, is dispersed in a matrix of a water insoluble material, e.g., a polystyrene polymer, to form a skin engaging member also known as a shaving aid strip, a shaving aid composite, or a lubricating strip. The skin engaging member is mounted in or on razor cartridge structures, adjacent the shaving edge or edges as disclosed e.g. in U.S. Pat. No. 4,170,821 to Booth and U.S. Pat. No. 5,113,585 to Rogers. Upon exposure to water, the water soluble shaving aid leaches from the matrix of the skin engaging member onto the skin. The water insoluble matrix maintains the integrity of the skin engaging member during normal use.

These types of skin engaging members can have deficiencies. The apparent deposition rate of the water soluble shaving aid onto the user's skin can be non-uniform as the water soluble shaving aid is leached from different regions or depths of the skin engaging member. Furthermore, some water insoluble matrices do not permit complete leaching of all water soluble shaving aid present, and are thus wasteful.

### SUMMARY

The present disclosure has for its objective to eliminate, or at least substantially alleviate the limitations of the prior art by providing a method of making a skin engaging member for a razor cartridge. The method lies in providing a precursor comprising a first water soluble polymer in a matrix of a water insoluble polymer. The precursor includes an upper surface region defining a thickness portion. A powdered second water soluble polymer is applied to an outer surface of the upper surface region. The second water-soluble polymer is mechanically pressed (e.g. by a roller) to embed the second water soluble polymer into the upper surface region. The upper surface region of the skin engaging member thus formed has a combined first and second water soluble polymer gradient in the thickness portion so that a combined first and second water soluble polymer content in an upper surface region portion closer to the outer surface is higher than in a combined first and second water soluble polymer content in an upper surface region portion remote from the outer surface.

The precursor can be one of an injection molding (e.g. a multi-shot injection molding formed together with a housing for the razor cartridge) or an extrudate. The extrudate can be provided in continuous form (i.e. at the step of applying the second water soluble polymer) and subsequently cut to length to suit the razor cartridge or can be cut to length before or at the step of applying the second water soluble polymer.

In some aspects the press tool, e.g. the roller can be heated to a surface temperature between about 100 C and about 250 C, preferably about 175 C. In some aspects the outer surface of the press tool, e.g. the perimeter of the roller can be textured to impart a corresponding reverse texture to the outer surface. In some aspects the second water soluble polymer can be applied by sprinkling the second water soluble polymer on the outer surface which can be pre-dampened. The second water soluble polymer can also be applied by drawing the molded housing or the extrudate through a volume of the second water soluble polymer. In order to ensure the molded housing or the extrudate is adequately covered the volume of the second water soluble polymer can be agitated at a sonic or an ultrasonic frequency. Both the first and the second water soluble polymers can comprise polyethylene oxide.

A skin engaging member manufactured by the method disclosed has a beneficial deposition rate of its water soluble shaving aid during normal use of the razor cartridge it is mounted in or on. The second water soluble polymer does not experience a typical heat cycle during e.g. molding or extrusion as the first water soluble polymer. Molecular degradation, e.g. scission (both chain and random scission) of the second water soluble polymer is generally avoided.

These and other advantages of the present disclosure will be apparent to one of ordinary skill in the art in light of the following Detailed Description and Drawings.

### BRIEF DESCRIPTION OF THE DRAWINGS

Reference is made to the attached drawings, wherein elements having the same reference numeral designations represent like elements throughout, and wherein:

FIG. 1 is a perspective view of a razor cartridge;

FIG. 2 is a sectional view taken at line 2-2 of FIG. 1;

FIG. 3 is a plan view of another razor cartridge;

FIG. 4 is a sectional view of the skin engaging member of FIG. 2;

FIG. 5 is a schematic view of a manufacturing process for a skin engaging member;

FIG. 5A is another process step;

FIG. 6 is a schematic view of another manufacturing process for a skin engaging member; and

### DETAILED DESCRIPTION

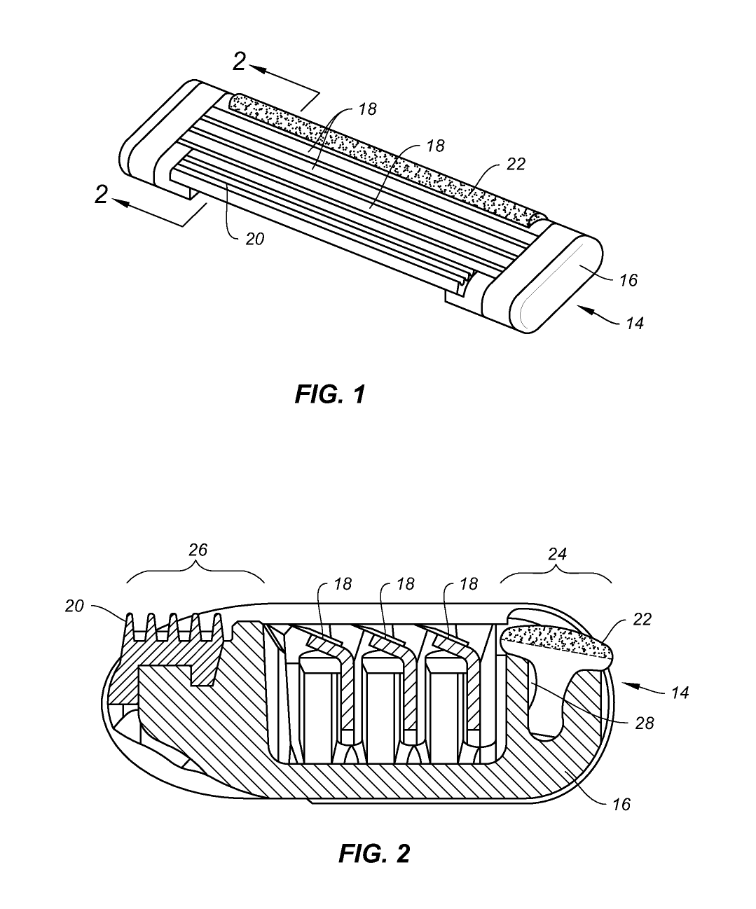

Referring to the drawings and in particular FIGS. 1 and 2 a razor cartridge 14 includes one or more razor blades 18. Three blades 18 are depicted in these Figs but the present disclosure is not limited in this regard and any number of razor blades 18 can be provided. The razor blades 18 are carried by a housing 16 which can also include a finned elastomeric guard 20. The razor cartridge also includes a skin engaging member 22 also known as a shaving aid strip which can be provided in the cap region 24 of the housing 16 (i.e. after the razor blades 18 relative to a stroke direction of the razor cartridge 14 during normal use) and/or in the guard region 26 of the housing 16, before the razor blades 18 and/or between the razor blades 18. In FIGS. 1-3 the razor blades 18 are shown facing in a common direction, however this should not be considered limiting and razor blades 18 facing in several directions such that the razor cartridge 14 can be used bi- or omni-directionally are within the scope of the present disclosure.

The skin engaging member 22 is in the form of a narrow elongated strip of dimensions suitable for placement on the housing 16 and can be manufactured in any size or shape deemed appropriate. The skin engaging member 22 can be locked e.g. snap-fitted in an opening 28 in the rear of the housing 16. The skin engaging member 22 can also be secured to housing 16 by other methods such as ultrasonic welding or gluing.

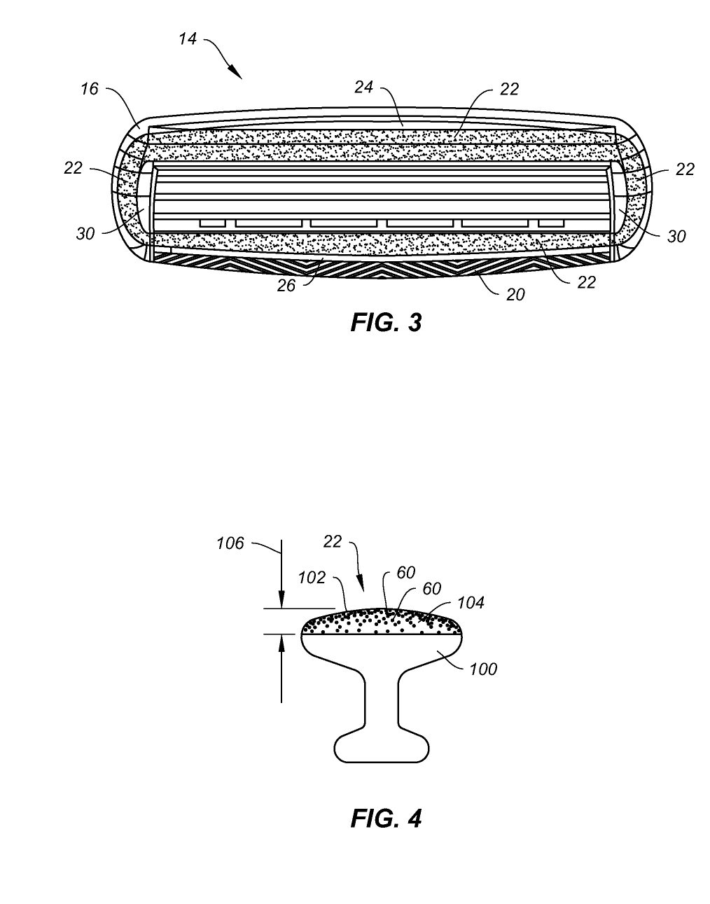

Referring now to FIG. 3 a plan view of another razor cartridge 14 is depicted. The skin engaging member 22 is in the cap region 24 of the housing 16 and also in the guard region 26 of the housing 16. The skin engaging member 22 also extends along lateral side edges 30 of the housing 16. The skin engaging member can be provided in a multi-shot, e.g. a two-shot molding process together with the housing 16.

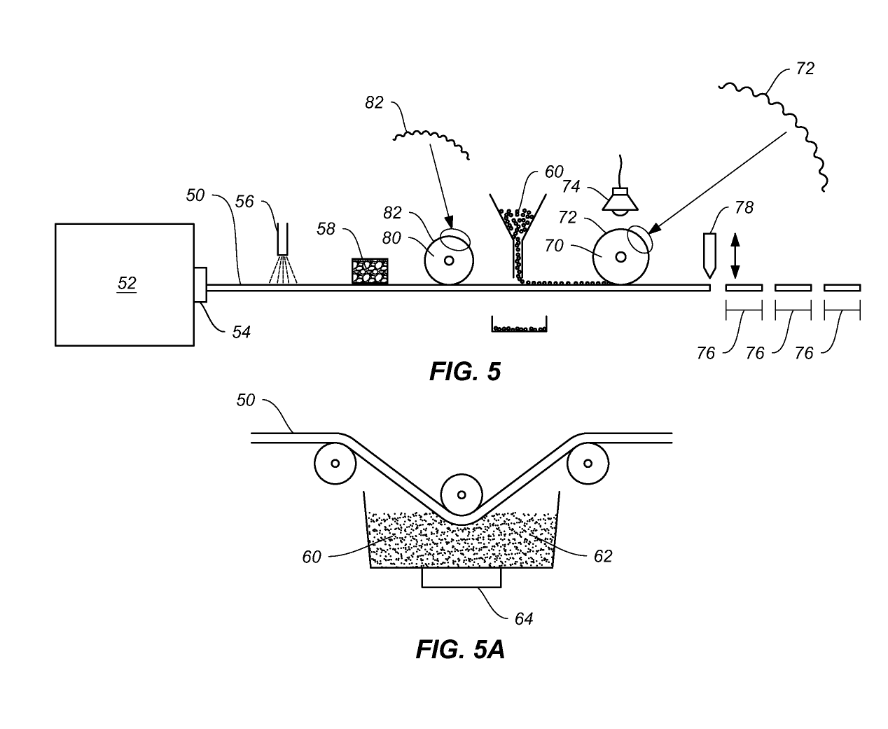

In FIG. 5 an exemplary process for the manufacture of a skin engaging member is depicted in schematic form. An extrudate 50 provides a precursor for the skin engaging member. The extrudate 50 comprises a first water soluble polymer in a matrix of a water insoluble polymer, all such polymeric materials being described later in the present disclosure. The extrudate is produced in an extruder 52 and its exterior shape is formed by die 54. A second water soluble polymer 60 in powder form is applied, e.g. sprinkled on an outer surface of an upper surface region of the extrudate. Excess or overflow powder can be captured and recycled. To promote the temporary adhesion of the powdered water soluble polymer to the outer surface, the outer surface can be lightly dampened, e.g. by misting 56 with water or by application of a dampened body 58, e.g. a sponge. A roller 70 applies a force of about 3N to 20N, preferably about 7N to the outer surface to embed the powdered second water soluble polymer into the outer surface region of the extrudate. The perimeter 72 of the roller 70 can be heated e.g. by an infra-red lamp 74 or by another suitable method to a temperature between about 100 C and about 250 C, preferably about 175 C, the temperature being measured and controlled by an infra-red thermometer. The perimeter 72 of the roller 70 can be textured to impart a corresponding reverse texture to the outer surface as will be discussed later in the present application. The roller can be formed from aluminum or copper for benefits of these materials' thermal properties. The roller can also be constructed with an aluminum or copper outer ring and with an intermediate ring of an insulating material. The extrudate 50 is cut to length 76 suitable for use on a housing 16 for razor cartridge 14 e.g. by a reciprocating blade 78.

In FIG. 5A an alternative process step to apply the second water soluble polymer 60 to the extrudate 50 is shown. The extrudate is drawn through a volume 62 of the second water soluble polymer 60. In order to ensure the extrudate is adequately covered, the volume 62 of the second water soluble polymer 60 can be agitated at a sonic or an ultrasonic frequency by a suitable driver 64.

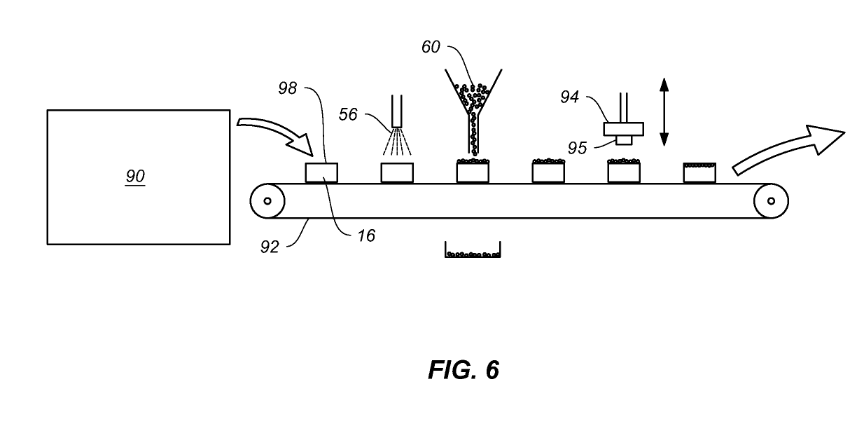

In FIG. 6 another exemplary process for the manufacture of a skin engaging member is depicted in schematic form. A molding 98 comprising a housing 16 for a razor cartridge is molded together with a precursor of a skin engaging member by an insert- or a multi-shot molding machine 90. The molding is transported, e.g. by conveyor 92 where a second water soluble polymer 60 is applied to an outer surface of an upper surface region of the precursor as described above. The molding can be pre-dampened as previously described. A reciprocating press tool 94 having a die 95 which can be heated and/or textured as previously described applies a pressure to the outer surface to embed the second water soluble polymer 60 into the outer surface region. The molding 98 is removed for subsequent manufacturing steps.

Providing a texture to the perimeter 72 of the roller 70 or to the die 95 of the reciprocating press tool 94 imparts a corresponding reverse texture to the outer surface 104 (see FIG. 4) of the skin engaging member 22. The effective surface area of the outer surface 104 is increased enabling an increased quantity of water soluble polymer to be leached onto the skin The imparted texture can be a series of ridges and valleys extending along or across a length of the skin engaging member, a regular or random pattern of protrusions and combinations of thereof. A texture can also be provided to the outer surface 104 of the extrudate 50 at the die 54 or by a second roller 80 with a textured perimeter 82, which second roller 80 can be positioned before or after roller 70.

Typical lubricious water-soluble polymers include polyethylene oxide, polyvinyl pyrrolidone, polyacrylamide, modified hydroxyalkyl cellulose, polyvinyl imidazoline, polyvinyl alcohol, polysulfone and polyhydroxyethylmethacrylate. The preferred lubricious water-soluble polymer is polyethylene oxide. The more preferred polyethylene oxides generally are known as POLYOX (available from Dow Chemical Company) or ALKOX (available from Meisei Chemical Works, Kyoto, Japan). These polyethylene oxides preferably have molecular weights (MW) of about 100,000 to 8 million. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g. POLYOX COAGULANT) and about 60% to 20% of polyethylene oxide having an average molecular weight of about 300,000 (e.g. POLYOX WSR-N-750). A 60:40 blend of these two polyethylene oxides (5 million:300,000) is especially preferred.

The second water soluble polymer can be the same as the first water soluble polymer (blend) or can be different or a different blend.

Suitable water-insoluble polymers which can be used include polyethylene, polypropylene, polystyrene, butadiene-styrene copolymer (e.g. medium and high impact polystyrene), polyacetal, acrylonitrile-butadiene-styrene copolymer, ethylene vinyl acetate copolymer, polyurethane and blends thereof such as polypropylene/polystyrene blend or polystyrene/impact polystyrene blend. The more preferred water-insoluble polymer is polystyrene, preferably a general purpose polystyrene, such as NOVA C2345A, or a high impact polystyrene (i.e. polystyrene-butadiene), such as NOVA 5410 or Total 975E. The extrudate or any other molded portion should contain a sufficient quantity of water-insoluble polymer to provide adequate mechanical strength, both during production and use.

In FIG. 4, a sectional view of a skin engaging member 22 e.g. of FIG. 1 is shown. A precursor 100 comprises a first water soluble polymer in a matrix of a water insoluble polymer as previously described. A powdered second water soluble polymer 60 is applied to, and embedded in an outer surface 102 of an upper surface region 104. The second water soluble polymer 60 is embedded to a depth 106 defining the thickness of the outer surface region. The combined water soluble polymer concentration in the upper surface region 104 is greater than in the remaining volume of the precursor 100. The combined water soluble polymer concentration close to the outer surface 102 of the upper surface region 104 is higher than the combined concentration in an upper surface region portion remote from the outer surface.

Since the second water soluble polymer does not undergo a heat cycle as typically experienced in an extrusion or molding process the second water soluble polymer generally does not suffer molecular degradation, e.g. scission (both chain and random scission) and the skin engaging member provides shaving benefits. Further benefits are provided by the shaving aid member exhibiting a beneficial deposition or leaching rate of water soluble polymer(s) during use.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. For example, the process steps to apply and embed the second water soluble polymer can be repeated to further locally increase a combined water soluble polymer content. The roller or press tool can be driven or agitated at a sonic or ultrasonic frequency to enhance the embedding process step. Features disclosed in connection with any one embodiment can be used alone or in combination with each feature of the respective other embodiments.

What is claimed is:

1. A method of making a skin engaging member for a razor cartridge, comprising:
a) providing a precursor comprising a first water soluble shaving aid dispersed in a matrix of a water insoluble polymer, wherein the precursor includes an upper surface region defining a thickness;
b) applying a powdered second water soluble shaving aid to an outer surface of the upper surface region; and
c) mechanically pressing the second water-soluble shaving aid to embed the second water soluble shaving aid into the upper surface region;

2. The method of claim 1, wherein the upper surface region has a combined first and second water soluble shaving aid gradient in the thickness so that a combined first and second water soluble shaving aid content in an upper surface region portion closer to the outer surface is higher than the combined first and second water soluble shaving aid content in an upper surface region portion remote from the outer surface.

3. The method of claim 1, wherein the outer surface is dampened prior to step b).

4. The method of claim 1, wherein the precursor is one of an injection molding and an extrudate.

5. The method of claim 4, wherein when the precursor is an extrudate the extrudate is in continuous form before step b) and is cut to a length to suit the razor cartridge after step c).

6. The method of claim 4, wherein, when the precursor is an extrudate, step c) is performed by an application of a roller.

7. The method of claim 6, wherein a perimeter of the roller is heated to a temperature between 100 C and 250 C, preferably 175 C.

8. The method of claim 6, wherein a perimeter of the roller is textured to impart a texture to the outer surface.

9. The method of claim 4, wherein, when the precursor is an injection molding, step c) is performed by an application of a reciprocating die.

10. The method of claim 9, wherein the die is heated to a temperature between about 100 C and about 250 C, preferably 175 C.

11. The method of claim 9, wherein the die is textured to impart a texture to the outer surface.

12. The method of claim 4, wherein step b) is performed by one of sprinkling the second water soluble shaving aid on the outer surface and, when the precursor is an extrudate, drawing the extrudate through a volume of the second water soluble shaving aid.

13. The method of claim 12, wherein the volume of the second water soluble shaving aid is agitated at one of a sonic and an ultrasonic frequency.

14. The method of claim 1, wherein both the first and the second water soluble shaving aids comprise polyethylene oxide.

15. A skin engaging member for a razor cartridge, comprising:
a precursor comprising a first water soluble shaving aid dispersed in a matrix of a water insoluble polymer, wherein the precursor includes an upper surface region having an outer surface and defining a thickness; and
a powdered second water soluble shaving aid embedded in the upper surface region;
wherein the upper surface region has a combined first and second water soluble shaving aid gradient in the thickness so that a combined first and second water soluble shaving aid content in an upper surface region portion closer to the outer surface is higher than in the combined first and second water soluble shaving aid content in an upper surface region portion remote from the outer surface.

16. The skin engaging member of claim 15, wherein both the first and the second water soluble shaving aids comprise polyethylene oxide.

17. The skin engaging member of claim 15, wherein the outer surface is textured.
